(19) United States
(12) Patent Application Publication
(10) Pub. No.: US 2020/0019432 A1
(43) Pub. Date: Jan. 16, 2020

(54) Information Resource Task Management

(71) Applicant: John Hellerman, Washington, DC (US)

(72) Inventor: John Hellerman, Washington, DC (US)

(73) Assignee: Hellerman Communications LLC, Washington, DC (US)

(21) Appl. No.: 16/511,512

(22) Filed: Jul. 15, 2019

Related U.S. Application Data
(60) Provisional application No. 62/700,959, filed on Jul. 20, 2018.
(60) Provisional application No. 62/698,486, filed on Jul. 16, 2018.

(51) Int. Cl. G06F 9/48

(52) U.S. Cl. CPC G06F 9/4818

(57) ABSTRACT

A system for targeting information resources that includes a task point value, and a preference vector comprising plural task designators for system performance and a preference allocation associated with each of said plural task designators. The system deducts from the task point value the preference allocation associated with a select one of the plural task designators upon completion of the select one of the plural task designators, to yield a net task point value. The system determines if the net task point value exceeds zero, and directs the system to terminate execution of tasks if the net task point value is equal to or less than zero.

### BACKGROUND OF THE INVENTION

This invention relates to systems and methods for managing information resource tasks.

### SUMMARY OF THE INVENTION

The present invention provides a system and method of managing information resource tasks in accordance with user preferences for completion of a select number of those tasks. It is particularly useful in information resource systems able to perform and accomplish multiple tasks without substantial preference from the system perspective as to which to complete, in comparison to the user, which may prefer completion of select tasks over others. It is particularly useful where accomplishing a set of tasks is not entirely determinable in advance, but rather is a function of system capabilities and/or the nature of the task itself.

In one aspect, the present invention is directed to a system for user targeting of information resources. The system includes a task point value and a preference vector, where the preference vector comprises plural task designators for system performance and a preference allocation associated with each of said plural task designators. The system is operative to deduct from the task point value the preference allocation associated with a select one of the plural task designators upon completion of the select one of the plural task designators, to yield a net task point value, as well as determine if the net task point value exceeds zero. If the net task point value is equal to or less than zero, the system terminate execution of tasks yet to be completed.

These and other aspects of the present invention are described in the drawings annexed hereto, and in the description of the preferred embodiments and claims set forth below.

### BRIEF DESCRIPTION OF THE DRAWINGS

FIG. 1 is a schematic of the system inputs and outputs in accordance with the present invention.

FIG. 2 is a table showing the data structure of the preference vector, as utilized in the present invention.

FIG. 3 is flow diagram illustrating the system operation in accordance with the present invention.

### DETAILED DESCRIPTION OF THE PREFERRED EMBODIMENTS

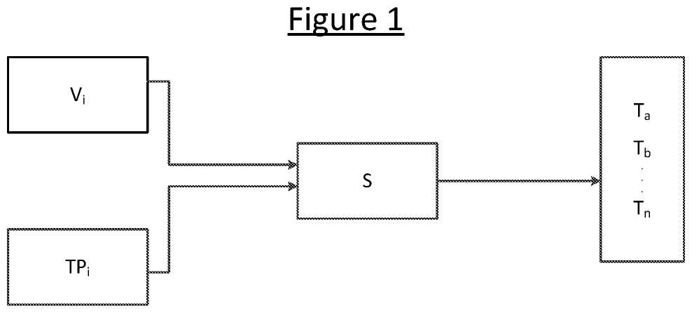

In the embodiment of the present invention depicted in FIG. 1, there is provided an information processing system S that is adapted to carry out n plural tasks, Tₐ, T_{b} . . . Tₙ, of a task environment set TE. The present invention is adapted both for a task environment TE where the tasks can be carried out with certainty, and also where there is uncertainty as to whether any specific task Tⱼ can in fact be accomplished, where Tⱼ is one task (i.e., the jth task) of the n plural tasks Tₐ, T_{b} . . . Tₙ of TE. Such uncertainty as to successful completion of task Tⱼ may exist, for example, where accomplishing task Tⱼ requires meeting criteria extrinsic or outside the control of system S. The present invention is particularly suitable where there is a reasonable level of confidence that at least some of tasks, Tₐ, T_{b} . . . Tₙ can be successfully conducted by system S.

System S is adapted for use by n plural users, U₁, U₂ . . . Uᵢ . . . Uₙ, each of which desires the performance of one or more tasks in task environment TE on its behalf. The tasks any user Uᵢ (i.e., the ith user) wishes the system S to perform, those tasks being designated in this disclosure for example as the set iTₐ, iT_{b} . . . iTₖ, need not be the same for all users Uₙ, but can vary among users. For example, user U₁ may desire system S to perform tasks T₁, T₂ and T₃, whereas user U₂ may desire system S to perform tasks T₂, T₃, T₄, and T₅. Thus system S is adapted to permit any user U₁ to request the system S to perform all tasks T₁ . . . Tₙ in task environment set TE, or any subset thereof.

System S carries out the tasks denominated by each user in accordance with the nature of each task and the available system resources. For example, tasks may be carried out serially, on behalf of one user at a time, or on behalf of plural or all users simultaneously, again according to the nature of the tasks and system resource availability. System S preferably includes computerized data processing capabilities, comprising input/output devices, a memory for retention of data and program instructions, and an arithmetic and logic unit for program execution and data manipulation in accordance with the teachings of this disclosure, and may also include other electronic and electro-mechanical apparatus and systems for task execution in conjunction with or at the direction of the computerized data processing capabilities and/or operator personnel.

The operation of system S on behalf of any user Uᵢ is a function of the task point value TPᵢ associated with that ith user and the preference vector Vᵢ associated with that user, both as explained presently.

### Task Points

The task points, TP, is a numerical value that can be assigned to or selected by each user of system S. The numerical value of TP can be varied in value, depending upon the user. Thus the task points, TPᵢ, assigned to or selected by each user, Uᵢ, need not be the same across all users Uₙ, but can differ among users, some having a larger TP value, and some having a smaller TP value. In one embodiment of the present invention, the number of task points TP assigned to or selected by a user is a function of the monetary payments the user makes to the operator of or organization responsible for system S.

System S is adapted to receive as an input the number of task points TP, of each user Uᵢ. The task points TPᵢ of each user Uᵢ are used by system S to determine the upper bound on user Uᵢ's entitlement to system resources, as explained further below.

### Preference Vectors

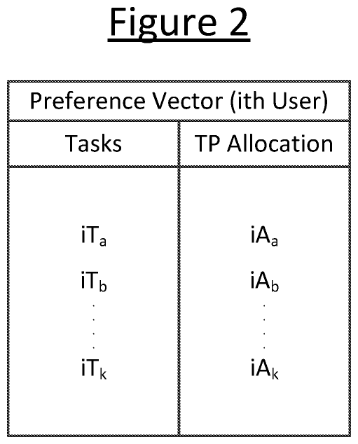

System S is further adapted to receive as an input from each user Uᵢ a preference vector, mentioned above. As shown in FIG. 2, the data structure of the preference vector Vᵢ for any user Uᵢ is an array of two columns and k rows, where the number of rows k corresponds to a number of tasks, more than one and less than or equal to n. Prior to system operation on behalf of each user Uᵢ, that user selects which of tasks Tₐ, T_{b} . . . Tₙ it wishes to have system S perform, and then populates one of the columns of preference vector Vᵢ with the identity of each of those tasks, denominated iTₐ, iT_{b} . . . iTₖ in this disclosure.

In addition to selecting which of tasks Tₐ, T_{b} . . . Tₙ it wishes to have system S perform, user Uᵢ additionally ranks the selected tasks according to the importance to user Uᵢ of accomplishing the task. In one embodiment, user Uᵢ provides this ranking to system S by dividing TPᵢ into k numerical allocations, iAₐ, iA_{b} . . . iAₖ, such that the sum of iAₐ, iA_{b} . . . iAₖ equals TPᵢ. After dividing TPᵢ in such a manner, each of those k allocations is then associated with a corresponding task of iTₐ, iT_{b} . . . iTₖ, with tasks of higher importance being associated with a correspondingly larger numerical member of iAₐ, iA_{b} . . . iAₖ. Thus, for the ith user, selected task iTₐ is accorded allocation iAₐ, selected task iT_{b} is accorded allocation iA_{b}, and so on. The user's k allocation selections are used to populate the second column of the user's preference vector Vᵢ, with each task point allocation placed in the same row as the corresponding task, as shown in FIG. 2. The task points TP allocated to that user and the user's preference vector V is then input or delivered to system S.

As specific examples of the foregoing, if system S is capable of performing ten tasks T₁, T₂ . . . T₁₀, and user number 3 has 50 task points, i.e., 50 TP, then user 3 can allocate all of those 50 task points to one task; i.e., assign that task an allocation A of fifty points. Alternatively, user number 3 can divide its 50 task points equally among the ten tasks (according each task an allocation A of five points). As another example, user number 3 can select for system S to perform three of the ten available tasks, e.g. T₃, T₅, T₈, and assign task T₃ an allocation A of thirty points, task T₅ an allocation A of fifteen points and task T₈ an allocation A of five points, or the like.

Although in the embodiment above, the sum of the allocations iAₐ, iA_{b} . . . iAₖ equals TPᵢ, in an alternative embodiment the user Uᵢ can choose k numerical allocations, iAₐ, iA_{b} . . . iAₖ, that when summed do not equal TPᵢ, but rather exceed it. This alternative embodiment has utility in the case for example where user Uᵢ has a relatively large number of tasks it has an interest in seeing completed, but where achieving a certain number in itself is a satisfactory result.

### System Operation

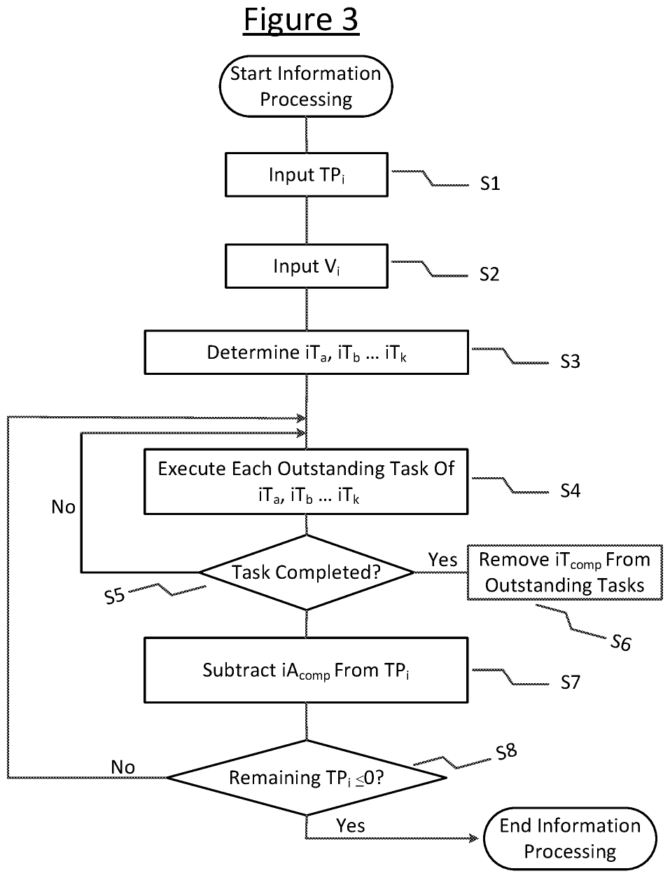

FIG. 3 illustrates the information processing method of the present invention, referring for convenience of illustration to the ith user, Uᵢ. In step S1, the task points TPᵢ are input to system S. In step S2, the preference vector Vᵢ is input to the system S. Alternatively, steps S1 and S2 can be carried out in reverse order or simultaneously, in accordance with system S characteristics.

Next, system S utilizes the preference vector Vᵢ to allocate system resources in accordance with the tasks T populating the preference vector. Thus in step S3, system S refers to the preference vector Vᵢ to determine the tasks iTₐ, iT_{b} . . . iTₖ selected by user Uᵢ, which become the outstanding tasks to be carried out for the initial iteration of operation of system S on behalf of that user. In Step S4, system S proceeds to carry out each of those outstanding tasks. Only those tasks identified in preference vector Vᵢ are conducted by the system on behalf of a user Uᵢ. As indicated above, system S carries out the tasks chosen by that ith user in accordance with the nature of each task and the available system resources.

In Step S5, system S determines whether any of the outstanding tasks of tasks iTₐ, iT_{b} . . . Tₖ have been completed in the Step S4 immediately preceding in time. If none has been completed, execution of the outstanding tasks is continued, as shown in Step 4.

If however, it is determined in Step S5 that an outstanding task of tasks iTₐ, iT_{b} . . . iTₖ has been completed in the Step S4 immediately preceding in time (which task is denominated iT_{comp} in this disclosure), then in Step S6 that completed task iT_{comp} is removed from among the outstanding of tasks of iTₐ, iT_{b} . . . Tₖ. Additionally, in Step S7 the allocation iA associated with that completed task iT_{comp} in the preference vector Vᵢ, (which allocation is denominated iA_{comp} in this disclosure) is deducted from TPᵢ. Alternatively, Steps S7 and S8 can be carried out in reverse order or simultaneously, in accordance with system S characteristics.

Next in Step S8, it is determined whether the remaining value of TPᵢ is equal to or less than zero. If that balance does not equal zero, then execution of the outstanding tasks is continued as shown in Step S4. If however, that balance is equal to or less than zero, then task processing terminates for the ith user. Once the task points reach zero, the user's entitlement to system resources is terminated as shown, even if there are tasks remaining in the user's preference vector.

### Example

The present invention has a great variety of applications. In the following example, the invention is used in connection with a programmed computer with functionality adapted to provide advertising services.

For this exemplary functionality, User Uₑₓ is a services vendor that has eleven advertising services tasks it would like completed. Uₑₓ is allocated a task point numerical value TPₑₓ of 35,000, and allocates TPₑₓ in accordance with its preference for achievement of these tasks. Table 1 below thus gives an exemplary Preference Vector Vₑₓ for this user Uₑₓ:

TABLE 1

| Tasks | Points |
|---|---|
| exT₁: Prospect inquiry generated | exA₁: 10,000 |
| exT2: Speaking engagement secured | exA2: 5,000 |
| exT3: Mention in major news print media | exA3: 3,000 |
| exT4: Mention in other news print media | exA4: 2,000 |
| exT5: Mention in top trade journal | exA₅: 2,000 |
| exT6: Mention in other trade journal | exA6: 2,000 |
| exT7: Mention at nationwide marketing | exA7: 2,000 |
| association meeting | |
| exT8: Mention at other marketing | exA₈: 1,500 |
| association meeting | |
| exT9: Mention by top blogger | exA9: 1,500 |
| exT10: Mention by other blogger | exA10: 1,000 |
| exT11: Increase Twitter followers to | exA₁₁: 5,000 |
| 5,000 | |

For this exemplary functionality, the value of TPₑₓ and the preference vector Vₑₓ are input to system S, which can include automated or other means for soliciting, from the entities identified in the tasks set forth in the first column of Table 1, and which entities are external and outside the control of the system S, a response in accordance with the requested tasks. Execution of the tasks proceeds in accordance with the system operation described above. Thus for example, if Uₑₓ is mentioned in a major news print medium (accomplishing task exT₃), then 3,000 points (exA₃) are subtracted from the initial TPₑₓ of 35,000, leaving 32,000 task points for completion of other desired tasks. Execution of the remaining tasks are carried out to successful completion until all remaining task points are exhausted, in which case system operation terminates.

The foregoing detailed description is for illustration only and is not to be deemed as limiting the inventions, which are defined in the appended claims.

What is claimed is:

1. A system for targeting information resources comprising:
An information processing system including a memory adapted to store data and a processor adapted to conduct computational and logical operations in respect of said stored data,
A task point value stored in said memory,
A preference vector stored in said memory, said preference vector comprising plural user-selected task designators for system performance and a user-selected preference allocation associated with each of said plural task designators,
a program, executable by said information processing system, operative to:
deduct from the task point value the preference allocation associated with a select one of the plural task designators upon completion of the select one of the plural task designators, to yield a net task point value,
store the net task point value,
determine if the net task point value exceeds zero, and
direct the system to terminate execution of tasks if the net task point value is equal to or less than zero.
